(19) United States
(12) Patent Application Publication
(10) Pub. No.: US 2005/0116059 A1
(43) Pub. Date: Jun. 2, 2005

(54) Supersonic atomizer for water-soluble essential oil

(76) Inventor: Yu-Chi Lin, Yonghe City (TW)

Correspondence Address: BRUCE H. TROXELL, SUITE 1404, 5205 LEESBURG PIKE, FALLS CHURCH, VA, 22041, US

(21) Appl. No.: 10/984,809

(22) Filed: Nov. 10, 2004

(30) Foreign Application Priority Data
Nov. 26, 2003 (TW) 92220918

(51) Int. Cl. B05B 1/08

(52) U.S. Cl. 239/102.2; 239/102.1; 239/289

(57) ABSTRACT

A supersonic atomizer for water-soluble essential oil includes a main body having electronic elements mounted therein. The electronic elements are powered via an externally connected power cord to actuate an oscillating chip mounted in a recess provided on a top surface of the main body to directly contact with water-soluble essential oil contained in a container, in which the atomizer is positioned. The oscillating chip powered via the electronic elements generates ultra-high-frequency supersonic oscillations at a frequency higher than 1500 kHz, and thereby atomizes the water-soluble essential oil to produce mists less than 30 mm.

### FIELD OF THE INVENTION

The present invention relates to a supersonic atomizer for water-soluble essential oil, and more particularly to a supersonic atomizer that could be conveniently positioned in any type of water-soluble essential oil contained in any container to generate oscillations at a frequency higher than 1500 kHZ, and thereby atomizes the essential oil to produce mists thereof. The supersonic atomizer has low weight and is suitable for carrying along with a user.

### BACKGROUND OF THE INVENTION

Taiwanese New Utility Model Patent Publication No. 547087 discloses an atomizer for supersonic therapeutic agents, aromatics or essential oils. The atomizer includes a housing and a container mounted in the housing. The container is internally fitted with a plastic film bag, and has a supersonic oscillator externally mounted at a bottom surface thereof. An inner cap with vents is closed to a top of the container.

Taiwanese New Utility Model Patent Publication No. 535595 discloses a supersonic aromatizer, which mainly includes a base, a liquid container, a cap, a holder, an oscillating chip, a seat, an air extracting motor, and an externally connected circuit control box. In this patent, liquid aromatic agent contained in the liquid container is subjected to high-frequency vibration generated by the oscillating chip located at a bottom of the container and produces fragrant fine mists that are sprayed via a nozzle upward projected from the cap to diffuse in air.

Generally speaking, to avoid easy damage of the oscillator due to direct contact of it with the essential oil, the above-mentioned conventional supersonic atomizing devices usually have an oscillator that is externally mounted at the bottom of the liquid containers for the latter to generate high-frequency vibration and thereby atomize the liquid contained therein. However, with the supersonic oscillator permanently fixed to the bottom outside the container, only a very limited atomizing effect is produced. Moreover, since the supersonic oscillator could not be freely moved relative to the liquid container, it has only one function without the possibility of being used in different manners. Therefore, the conventional supersonic atomizing devices with such fixed supersonic oscillator have limited applications.

It is therefore tried by the inventor to develop an improved supersonic atomizer to overcome the drawbacks existed in the above-mentioned conventional supersonic atomizing devices.

### SUMMARY OF THE INVENTION

A primary object of the present invention is to provide a simple and convenient supersonic atomizer for water-soluble essential oil that is adapted to direct contact with and act on the water-soluble essential oil so as to provide an upgraded atomizing effect.

Another object of the present invention is to provide a supersonic atomizer for water-soluble essential oil that could be used in different containers depending on different environments, and thereby creates different atmosphere and environmental visual effects.

To achieve the above and other objects, the supersonic atomizer for water-soluble essential oil according to the present invention includes a main body having electronic elements mounted therein. The electronic elements are powered via an externally connected power cord to actuate an oscillating chip mounted in a recess provided on a top surface of the main body to directly contact with water-soluble essential oil contained in a container, in which the atomizer is positioned. The oscillating chip in direct contact with the essential oil and powered via the electronic elements generates ultra-high-frequency supersonic oscillations at a frequency higher than 1500 kHz, and thereby atomizes the water-soluble essential oil to produce mists less than 3 μm.

In the supersonic atomizer of the present invention, there is also included a digitally controlled sequential color-changing unit mounted on the top surface of the main body and including a plurality of light-emitting elements. The digitally controlled sequential color-changing unit is powered via the electronic elements to produce varying color light, allowing the supersonic atomizer to create an upgraded environmental visual effect.

The supersonic atomizer of the present invention further includes a level-sensing unit. When a level of the water-soluble essential oil in the container is lower than an upper conductive head of the level-sensing unit on the supersonic atomizer positioned in the essential oil, the supersonic oscillating chip is interrupted and the whole supersonic atomizer is protected against damage due to insufficient essential oil in the container.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a supersonic atomizer for water-soluble essential oil according to the present invention;

FIG. 2 is a perspective cutaway view showing an example of use of the present invention in a container to atomize essential oil contained therein; and

FIG. 3 is a plan cutaway view showing another example of use of the present invention in a container to atomize essential oil contained therein.

### DETAILED DESCRIPTION OF THE PREFERRED EMBODIMENTS

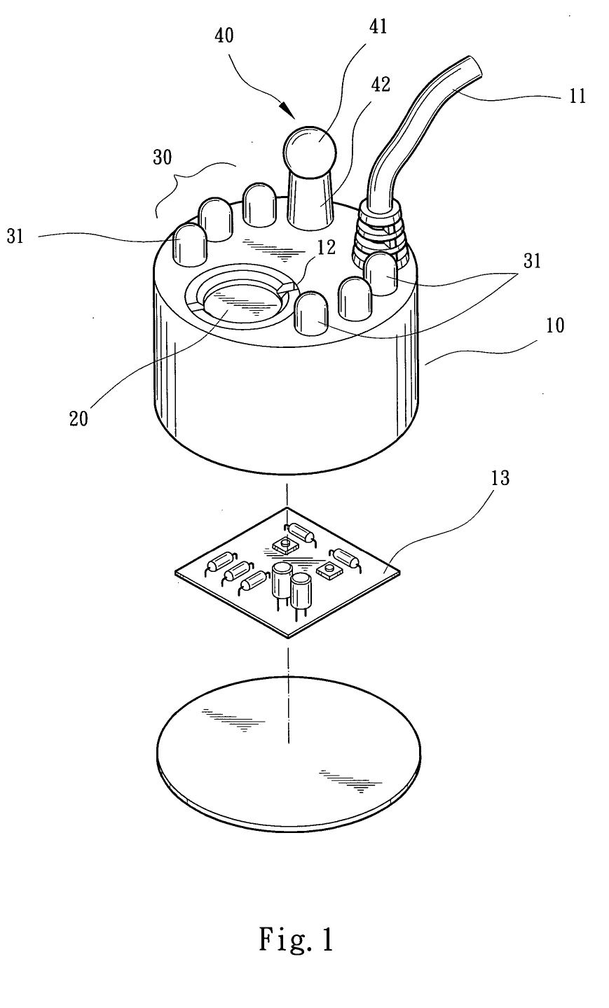

Please refer to FIG. 1 that is an exploded perspective view of a supersonic atomizer for water-soluble essential oil according to the present invention. As shown, the supersonic atomizer includes a main body 10, in which electronic elements 13 are mounted and powered via an externally connected power cord 11; and a supersonic oscillating chip 20 mounted in a recess 12 provided at a top surface of the main body 10, such that an upper surface of the chip 20 is exposed from the main body 10 and a lower surface of the chip 20 is electrically connected to the electronic elements 13. With ultra-high-frequency oscillating signals provided by the electronic elements 13, the supersonic oscillating chip 20 is adapted to generate oscillations at a frequency higher than 1500 kHz.

A digitally controlled sequential color-changing unit 30 is mounted on the top surface of the main body 10, and includes one or a plurality of light-emitting elements 31, such as single-color or multi-color light-emitting diodes (LEDs) to create varying color light as an effect of the internal electronic elements 13.

A level-sensing unit 40 is externally provided on the top surface of the main body 10 to electrically detect a level of essential oil outside the main body 10, such that the oscillating chip 20 is interrupted when the level of essential oil is lower than a preset height.

In the present invention, the oscillating chip 20 is set to oscillate at a frequency higher than 1500 kHz, so that water or any type of water-soluble liquid in contact with the oscillating chip 20 is atomized to produce mist of less than 30 μm.

The digitally controlled sequential color-changing unit 30 is controlled by the electronic elements 13 in the main body 10, such that the light-emitting element 31 emits different color light in a preset sequence. The varying color light produced by the digitally controlled sequential color-changing unit 30 and the mists of the water-soluble liquid produced by the oscillating chip 20 together create different environmental visual effects.

As can be seen from FIG. 1, the level-sensing unit 40 includes an upper part forming a conductive head 41, and a lower part forming a neck portion 42 downward extended from the conductive head 41. The neck portion 42 is covered with an insulating material to isolate from the water-soluble liquid and is therefore non-conducting. On the other hand, the upper conductive head 41 is electrically conductive in the water-soluble liquid to produce electric currents. The conductive head 41 may be differently shaped, such as, for example, a spherical or a cubical body. With the level-sensing unit 40, the supersonic atomizer of the present invention is electrically interrupted and accordingly, well protected from damage when the level of the water-soluble liquid in a container is lower than the upper conductive head 41 of the level-sensing unit 40 of the supersonic atomizer.

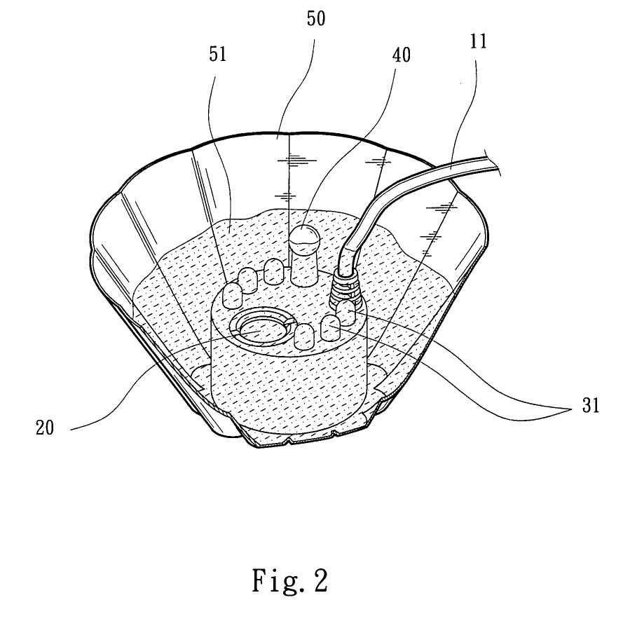

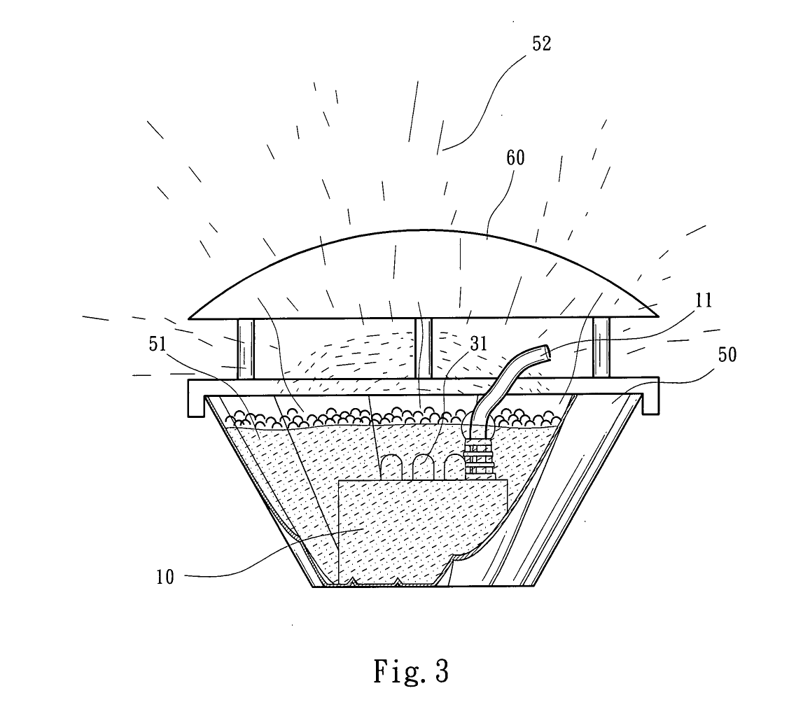

Please refer to FIGS. 2 and 3 for the operation of the supersonic atomizer for water-soluble essential oil according to the present invention. First, the main body 10 of the supersonic atomizer is positioned in a container 50 having an amount of water-soluble essential oil 51 contained therein. It is noted a level of the water-soluble essential oil 51 poured into the container 50 must be higher than the supersonic oscillating chip 20 by at least five to eight centimeters. Then, power is supplied to the supersonic atomizer. At this point, the essential oil 51 in direct contact with the oscillating chip 20 is powerfully oscillated to produce freshening and fragrant flows of mists 52. In this manner, it is possible to effectively control the consumption of the essential oil 51 and freely adjust a concentration of the produced mists 52. The use and design of the supersonic atomizer of the present invention is not restricted by the container 50, but may be changed depending on different environmental requirements. For example, a cap 60 may be added to a top of the container 50, as shown in FIG. 3, to function like an ornament while properly shielding the produced flows of mists 52.

With the above arrangements, the supersonic atomizer for water-soluble essential oil according to the present invention has largely reduced volume and weight and is more convenient for use. Moreover, since the supersonic atomizer of the present invention directly oscillates the essential oil, it provides an enhanced atomizing effect to overcome the drawbacks existed in the conventional atomizing devices.

The present invention has been described with a preferred embodiment thereof and it is understood that many changes and modifications in the described embodiment can be carried out without departing from the scope and the spirit of the invention that is intended to be limited only by the appended claims.

1. A supersonic atomizer for water-soluble essential oil, comprising a main body for positioning in a water-soluble liquid and having electronic elements mounted therein; and a supersonic oscillating chip mounted at a top surface of said main body to electrically connect to said electronic elements in said main body; and said supersonic oscillating chip being electrically controlled by said electronic elements to oscillate said water-soluble liquid and thereby produce mists of said water-soluble liquid.

2. The supersonic atomizer for water-soluble essential oil as claimed in claim 1, wherein said supersonic oscillating chip oscillates at a frequency of 1500 kHz under action of said electronic elements.

3. The supersonic atomizer for water-soluble essential oil as claimed in claim 1, further comprising a digitally controlled sequential color-changing unit, which creates color light varying in a preset sequence when said color-changing unit is electrically actuated by said electronic elements.

4. The supersonic atomizer for water-soluble essential oil as claimed in claim 2, further comprising a digitally controlled sequential color-changing unit, which creates color light varying in a preset sequence when said color-changing unit is electrically actuated by said electronic elements.

5. The supersonic atomizer for water-soluble essential oil as claimed in claim 3, wherein said color-changing unit includes at least one multi-color light-emitting diode.

6. The supersonic atomizer for water-soluble essential oil as claimed in claim 4, wherein said color-changing unit includes at least one multi-color light-emitting diode.

7. The supersonic atomizer for water-soluble essential oil as claimed in claim 1, further comprising a level-sensing unit provided on said main body.

8. The supersonic atomizer for water-soluble essential oil as claimed in claim 2, further comprising a level-sensing unit provided on said main body.

9. The supersonic atomizer for water-soluble essential oil as claimed in claim 3, further comprising a level-sensing unit provided on said main body.

10. The supersonic atomizer for water-soluble essential oil as claimed in claim 4, further comprising a level-sensing unit provided on said main body.

11. The supersonic atomizer for water-soluble essential oil as claimed in claim 7, wherein said level-sensing unit is a columnar element including an upper conductive head and a lower neck portion, and said neck portion being covered with an insulating material.

12. The supersonic atomizer for water-soluble essential oil as claimed in claim 8, wherein said level-sensing unit is a columnar element including an upper conductive head and a lower neck portion, and said neck portion being covered with an insulating material.

13. The supersonic atomizer for water-soluble essential oil as claimed in claim 9, wherein said level-sensing unit is a columnar element including an upper conductive head and a lower neck portion, and said neck portion being covered with an insulating material.

14. The supersonic atomizer for water-soluble essential oil as claimed in claim 10, wherein said level-sensing unit is a columnar element including an upper conductive head and a lower neck portion, and said neck portion being covered with an insulating material.

15. The supersonic atomizer for water-soluble essential oil as claimed in claim 1, wherein said water-soluble liquid is a type of water-soluble essential oil.

16. The supersonic atomizer for water-soluble essential oil as claimed in claim 2, wherein said water-soluble liquid is a type of water-soluble essential oil.

17. The supersonic atomizer for water-soluble essential oil as claimed in claim 3, wherein said water-soluble liquid is a type of water-soluble essential oil.

18. The supersonic atomizer for water-soluble essential oil as claimed in claim 4, wherein said water-soluble liquid is a type of water-soluble essential oil.

19. The supersonic atomizer for water-soluble essential oil as claimed in claim 5, wherein said water-soluble liquid is a type of water-soluble essential oil.

20. The supersonic atomizer for water-soluble essential oil as claimed in claim 6, wherein said water-soluble liquid is a type of water-soluble essential oil.

21. The supersonic atomizer for water-soluble essential oil as claimed in claim 7, wherein said water-soluble liquid is a type of water-soluble essential oil.

22. The supersonic atomizer for water-soluble essential oil as claimed in claim 8, wherein said water-soluble liquid is a type of water-soluble essential oil.

23. The supersonic atomizer for water-soluble essential oil as claimed in claim 9, wherein said water-soluble liquid is a type of water-soluble essential oil.

24. The supersonic atomizer for water-soluble essential oil as claimed in claim 10, wherein said water-soluble liquid is a type of water-soluble essential oil.

25. The supersonic atomizer for water-soluble essential oil as claimed in claim 11, wherein said water-soluble liquid is a type of water-soluble essential oil.

26. The supersonic atomizer for water-soluble essential oil as claimed in claim 12, wherein said water-soluble liquid is a type of water-soluble essential oil.

27. The supersonic atomizer for water-soluble essential oil as claimed in claim 13, wherein said water-soluble liquid is a type of water-soluble essential oil.

28. The supersonic atomizer for water-soluble essential oil as claimed in claim 14, wherein said water-soluble liquid is a type of water-soluble essential oil.
